(19) United States
(12) Patent Application Publication
(10) Pub. No.: US 2024/0384045 A1
(43) Pub. Date: Nov. 21, 2024

(54) METHOD FOR CURING AND RELEASING THERMOSETTING POLYMERS ON A COATED GLASS SUBSTRATE

(71) Applicant: PulseForge Inc., Austin, TX (US)

(72) Inventors: KURT A. SCHRODER, Coupland, TX (US); VAHID AKHAVAN ATTAR, Austin, TX (US); VIKRAM SHREESHAIL TURKANI, Austin (IN)

(73) Assignee: PulseForge Inc., Austin, TX (US)

(21) Appl. No.: 18/199,943

(22) Filed: May 20, 2023

(51) Int. Cl. C08J 3/24; C08J 3/28; C08L 63/00; C08L 79/08

(52) U.S. Cl. CPC C08J 3/247; C08J 3/28; C08L 63/00; C08L 79/08; C08J 2363/00; C08J 2379/08

(57) ABSTRACT

A method for curing thermosetting polymers on a glass substrate is disclosed. A light-absorbing layer is deposited on a glass substrate, and a thermosetting polymer precursor is then deposited on the light-absorbing layer in liquid form. After the thermosetting polymer precursor has been preheated, the thermosetting polymer precursor is then exposed to a light pulse from a flashlamp while it is being cooled simultaneously in order to maintain an average temperature of the thermosetting polymer precursor at below its maximum working temperature. After the thermosetting polymer precursor has been exposed to the light pulse, a gaseous by-product is allowed to dissipate from the thermosetting polymer precursor. The light pulse exposure step and the by-product dissipation step are repeated multiple times until a thermosetting polymer thin film is formed. Afterwards, the thermosetting polymer film is released from the light-absorbing layer.

### TECHNICAL FIELD

The present application relates to thermosetting polymers in general, and, in particular, to a method for curing and releasing thermosetting polymers on a coated glass substrate.

### BACKGROUND

Many functional materials can yield better performances after higher temperature processing; thus, it is more desirable to process thin film materials at higher temperatures. However, higher temperature processing generally requires higher temperature-rated substrates, and that almost always means more expensive substrates are required. For example, polyimide (PI) is a high-temperature polymer that is considered as superior over polyethylene terephthalate (PET)—the dominant low-temperature substrate material for printed electronics. But the curing of PI requires a higher temperature thermal processing for a longer period of time, which brings up three reasons that prevent PI from being widely adopted in more applications. First, maintaining the PI precursor at a high temperature for a long time is energy intensive, which will increase the cost of the final product. Second, the temperature and time for PI curing are beyond those which most polymers can withstand without being damaged, which means PI cannot be formed adjacent to many other polymers. Third, since the curing of PI generates a small amount of water, in the form of vapor, thick layers are essentially impossible. In other words, PI must be formed in thin films.

One of the applications of PI in printed electronics is as a backbone of a flexible circuit board. Often, the PI is formed separately and then attached to a rigid carrier with an adhesive in order to build electronic structures, place components, solder the components to the board, etc. After the electronic circuit is complete, the circuit is removed from the rigid carrier. There are a variety of techniques used to remove the circuit board from the carrier including mechanical peeling, chemical release, and laser irradiation from the backside of the carrier. These methods are slow, costly, and often result in damage of the electronic structures of the flexible circuit board.

Hence, even though PI is a very desirable material for the printed electronics industry due to its high temperature stability and chemical resistance; however, the adoption of PI is rare, largely because the curing of PI must be done at a high temperature for an extended period of time.

The current disclosure provides a method for curing and releasing thermosetting polymers on a coated glass substrate.

### SUMMARY OF THE INVENTION

In accordance with one embodiment, a light-absorbing layer is deposited on a glass substrate, and a thermosetting polymer precursor is then deposited on the light-absorbing layer in liquid form. After the thermosetting polymer precursor has been preheated, the thermosetting polymer precursor is then exposed to a light pulse from a flashlamp while it is being cooled simultaneously in order to maintain an average temperature of the thermosetting polymer precursor at below its maximum working temperature. After the thermosetting polymer precursor has been exposed to the light pulse, a gaseous by-product is allowed to dissipate from the thermosetting polymer precursor. The light pulse exposure step and the by-product dissipation step are repeated multiple times until a thermosetting polymer thin film is formed. After flipping over the glass substrate, the glass substrate is exposed to another series of light pulses from the flashlamp in order to release the thermosetting polymer film from the light-absorbing layer.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 illustrates a method for curing thermosetting polymers, according to one embodiment;

FIGS. 2A-2B show an example of curing PI on glass using an absorber layer, according to one embodiment; and

FIGS. 3A-3B show an example of curing epoxy on glass using an absorber layer, according to one embodiment.

### DETAILED DESCRIPTION OF A PREFERRED EMBODIMENT

The prior art method for curing a polyimide (PI) precursor to form a thin film PI is as follows. Initially, a PI precursor is deposited onto a substrate in liquid form. After placing the substrate in an oven to remove the liquid (or solvent) from the PI precursor at a high temperature, the PI precursor is then cured. For this prior art curing method, the temperature of the PI precursor is generally maintained at around 350° C. for about two hours in order to completely crosslink (imidize) the PI precursor. A lower temperature would cure the PI much slower, while a higher temperature can cure it faster. But if the temperature is too high and the crosslinking happens too quickly, the water vapor (or other volatiles) generated from the reaction cannot be released from the interior of the thin film without damaging it.

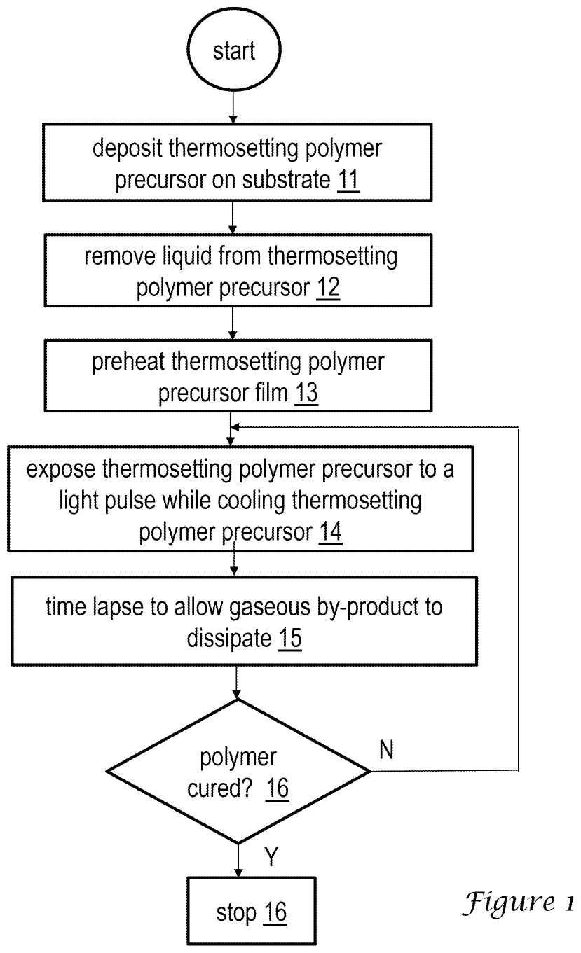

Referring now to the drawings and in particular to FIG. 1, there is depicted a method for curing thermosetting polymers, according to one embodiment. Examples of thermosetting polymers include polyimides, epoxies, silicones, and acrylics.

### Deposition

According to one embodiment of the present invention, a thermosetting polymer precursor is deposited on a substrate, as shown in block 11. Examples of thermosetting polymer precursor include polyamic acid and epoxy. The thermosetting polymer precursor can be deposited in liquid or solid form to about 1-100 microns thick. The thermosetting polymer precursor can be deposited on the substrate via a variety of full coat techniques including spin coat, doctor blade, roll coating, spray coating, etc. The thermosetting polymer precursor may also be selectively deposited on the substrate via inkjet, flexographic, gravure, syringe dispense, screen print, stencil print, etc. The substrate can be metal, glass, ceramic, semiconductor, or polymer. Instead of a single substrate, the thermosetting polymer precursor can also be deposited on a stack having multiple layers.

### Drying

If the thermosetting polymer precursor (such as polyamic acid—precursor for PI) is deposited in liquid form, the thermosetting polymer precursor is dried to remove the solvent from the thermosetting polymer precursor, as depicted in block 12. The drying may be performed by placing the thermosetting polymer precursor and the substrate in an oven. The environment may be inert to prevent the thermosetting polymer precursor from oxidizing. The thermosetting polymer precursor can also be dried using a near-infrared lamp. The thermosetting polymer precursor may also be dried using multiple light pulses from a flashlamp. When using the flashlamp approach for drying, an inert atmosphere is not necessary, and the peak temperature during each light pulse may be above the boiling point of the lowest boiling point solvent within the thermosetting polymer precursor, but the average temperature during the processing time may be below the boiling point of the lowest boiling point solvent in the thermosetting polymer precursor.

During the drying process, the thermosetting polymer precursor may be cooled by convection, such as by an air knife, or/and by conduction, such as a relatively thermally massive or/and actively temperature-controlled block that is in contact with the thermosetting polymer precursor directly or via its substrate or stack. When drying, both the peak and average temperature that can be reached without damaging the thermosetting polymer precursor is generally less than the peak and average curing temperature for the thermoset as the solvents in the thermosetting polymer precursor boil at a temperature below the maximum rated temperature of the thermosetting polymer precursor or fully cured thermoset. Some thermosetting polymer precursor, such as epoxy, do not need to be dried.

### Preheating

After drying (if necessary) and prior to curing, the thermosetting polymer precursor is preheated, as shown in block 13. The preheating can be performed by using a variety of methods, including hot air, near-infrared lamps, infrared lamps, conduction from an underlying chuck, rollers, or a flashlamp.

### Curing

Instead of using an oven for curing, a set of light pulses in conjunction with active cooling are then utilized to modulate the temperature of the thermosetting polymer precursor during curing. Initially, the thermosetting polymer precursor is exposed to a light pulse from a flashlamp while the thermosetting polymer precursor is being cooled at the same time in order to keep the average temperature of the thermosetting polymer precursor at below its maximum working temperature, as depicted in block 14. The thermosetting polymer precursor is heated by the light pulse to beyond its maximum steady-state working temperature, thereby increasing the cure (e.g., crosslinking) rate. At the same time, the thermosetting polymer precursor is also being cooled to below its maximum working temperature.

After the application of the light pulse, a predetermined amount of time is allowed to lapse in order to let any gaseous or volatile by-products to dissipate from the thermosetting polymer precursor, as shown in block 15.

A determination is made as to whether or not the thermosetting polymer precursor has been cured, as depicted in block 16. If the thermosetting polymer precursor has not been cured, the light pulse exposure step in block 14 and the by-product dissipation step in block 15 are repeated. If the thermosetting polymer precursor has been cured (i.e., a thermosetting polymer thin film is formed), the process is completed, as depicted in block 16 in FIG. 1.

Each time the thermosetting polymer precursor is exposed to a light pulse, the thermosetting polymer precursor is heated to a temperature that is higher than the thermosetting polymer precursor's maximum operating temperature. In the case of forming polyimide, this temperature is about 350° C. at the beginning of the cure and is about 400° C. when the thermoset precursor is fully imidized. At the peak of a light pulse, the temperature that can be reached in the thermosetting polymer precursor film is briefly (˜millisecond) higher (˜200° C. higher) than the steady-state maximum allowed temperature.

During processing, the thermosetting polymer precursor is also being cooled such that the average temperature of the surface of the thermosetting polymer precursor is lower than the steady-state maximum rate temperature of the thermosetting polymer material. The cooling is applied continuously and occurs during (1 millisecond) and between the light pulses (˜tens to hundreds of milliseconds). This light exposure/cooling is repeated multiple times until the thermosetting polymer precursor is completely crosslinked. The total processing time is approximately 5 seconds to 1 minute.

### Purpose of Cooling During Curing

In all cases, the total energy deposited into the thermosetting polymer precursor by the light pulse train is much greater than that required to thermally damage the thermosetting polymer precursor. Thus, in all cases, heat needs to be removed from the thermosetting polymer precursor, either by conduction or convection during processing in order to prevent the average temperature of the thermosetting polymer precursor from exceeding its maximum rated equilibrium temperature.

In addition, the by-product of the crosslinking process is typically of a lower boiling point than the cured polymer, and if left within the thermosetting polymer precursor at a high concentration would lead to bubbling and/or burning with subsequent light pulses. The cooling is necessary to maintain a suitable working temperature to remove the by-product but provide suitable access to the peak temperature necessary for further curing of the thermosetting polymer precursor. There is also a cooling effect due to the release of gas from the crosslinking process. The thermosetting polymer precursor may be cooled by conduction, convection, or both.

### Cooling by Conduction

The thermosetting polymer precursor may be in physical contact with a heat sink during exposure by the flashlamp. The heat sink can be a thermally massive chuck or roller made from metal, ceramic, graphite, glass, etc. The heat sink can be a substrate to which the thermosetting polymer precursor has been applied, providing the substrate is thick enough. Alternatively, the thermosetting polymer precursor can be located on a thin substrate that is in physical contact with a thermally massive heat sink mentioned above. In other words, the thermosetting polymer precursor is in physical contact with a large thermal mass. The areal density of the thermal mass is preferably 50-500 times greater than the areal density of the thermoset precursor film. In other words, the thermal mass, which may include the substrate, the chuck or roller, and any layers in between them are (50-500 times) thicker than the thermosetting polymer precursor's thickness. The chuck or roller may also be temperature controlled.

### Cooling by Convection

The thermosetting polymer precursor may be cooled via convection by using, for example, an air knife. Aside from providing cooling, an air knife has the added benefit of removing any gaseous by-products from the drying or curing process. An air knife may also be utilized in addition to conductive cooling mentioned above.

### Flashlamp Emission Absorption

The emission spectrum from the above-mentioned flashlamp is broadband and ranges from 200 nm to 1,500 nm. In order to heat the thermosetting polymer precursor, some of the emission bands from the flashlamp must be absorbed. Absorption may be performed by the thermosetting polymer precursor directly, any of the layers of a composite substrate, a chuck or rollers, or a combination thereof. Preferably, the absorption should be performed by the thermosetting polymer precursor or the substrate adjacent to it. In the case of forming polyimide, the precursor (polyamic acid) has a very sharp absorption transition at about 500 nm, meaning that it is very absorptive for wavelengths shorter than 500 nm, but is generally transparent at wavelengths longer than 500 nm. If the layer immediately below the thermosetting polymer precursor is absorptive of wavelengths over 500 nm, and an optical filter removing wavelengths below 500 nm is placed between the flashlamp and the polyimide precursor, then the polyimide polymer precursor can be heated readily via conduction.

Additionally, absorbers (light-absorbing materials) can be placed in the thermosetting polymer precursor to enhance its absorbance of the emissions. If it is desirable to maintain its transparency in the visible spectrum, then near-infrared absorbers may be placed in the thermosetting polymer precursor to increase its absorbance of the emissions.

In some cases, it is desirable to process the thermosetting polymer precursor without the use of ultra-violet (UV) light. A UV block filter may be placed in the beam and the curing may be performed with the visible and near infrared portions of the emissions. Absorbers may be placed in the thermosetting polymer precursor to increase absorption in the near-infrared potion of the spectrum without affecting the absorption of the thermosetting polymer precursor in the visible spectrum. Any light that is not absorbed by or reflected from the thermosetting polymer precursor may be absorbed by the substrate underneath it. In a preferred embodiment, a filter is inserted to remove all of the absorption of the flashlamp emission by the thermosetting polymer precursor, and absorption happens only immediately beneath the thermosetting polymer precursor.

### Temperature Measurement

The temperature of the surface of thermosetting polymer precursor as well as into the depth of the thermosetting polymer precursor, its underlying substrate and any conductive cooling means, either from a block or roller, or/and convective means, such as an air knife, can be simulated with SimPulse® (available from PulseForge, Inc., Austin, TX). This simulation can be validated provided that bolometry (measurement of the radiant exposure in J/cm²) of the pulses of light are measured as well as the temporal evolution of the radiant power from the flashlamp. Additional inputs to the simulation are the thermophysical properties of the stack including the absorption of the beam from the flashlamp, the heat capacity, the thermal conductivity, and thickness of each layer of the stack. Finally, the heat transfer coefficient and the temperature at the top and the bottom of the stack must be known. In this way, the heat input due to absorption of the pulse of light in the stack (it may be absorbed by a layer on top of the thermosetting polymer precursor, the thermosetting polymer precursor, the underlying substrate, the cooling chuck, or distributed between then) may be known. From this information, the peak temperature at any place into the depth of the stack, including the thermoset precursor film, can be determined as well as the average temperature of any place in the stack.

The surface of the thermosetting polymer precursor may be directly measured using a pyrometer. Since a pyrometer is generally only sensitive in the 10-micron range (10,000 nm), and the emission from the flashlamp is between 200 nm and 1,500 nm, the pyrometer is not sensitive to the emission from the flashlamp and can be used while the flashlamp is emitting light pulses. Additionally, a pyrometer also has a low frequency response and cannot resolve the rapid temperature increase of the thermoset due to absorption from the pulse of light from the flashlamp. Effectively, this means that a pyrometer measures the average temperature of the surface of the thermosetting polymer precursor during processing. For the present embodiment, the average thermosetting polymer precursor temperature does not exceed the average temperature limit of the thermoset precursor when the thermosetting polymer precursor is processed in an oven.

### Theory of Thermosetting Polymer Curing Method

The following is the theory explaining why the above-mentioned thermosetting polymer curing method works. When the thermosetting polymer precursor is maintained at a higher temperature, the crosslinking reaction progresses much more rapidly. However, in the case of many thermosetting polymer precursors, such as polyimide, the curing is generally limited to a processing temperature of about 350° C. in an oven. At this temperature, the crosslinking, or in the case of PI, the imidization process takes about two hours and the resulting thermosetting polymer film can withstand about 400° C. without any damage after it is fully cured. This temperature limitation problem can be circumvented by cycling the temperature to far higher (as much as 550° C.) than the typical imidization temperature of 350° C. for a brief amount of time, followed by a rapid cooling to well below 350° C., and repeating it many times until the imidization reaction is complete. The average temperature during processing is maintained at below the maximum working temperature of the precursor. This is accomplished by using a rapidly pulsed broadband light source, such as a flashlamp combined with means to continuously cool the thermosetting polymer precursor during processing. Light from the flashlamp is absorbed by the thermosetting polymer precursor, the substrate below it, or an absorber on top of it. When the light is absorbed, the thermosetting polymer precursor is heated either directly or in combination via conduction from an absorber on top of or below the thermoset precursor. When the thermosetting polymer precursor is heated, the crosslinking reaction ensues. This generates gaseous products, but before the gaseous products can build up enough to damage the film, the film is rapidly cooled to a temperature lower than the maximum rated temperature of the thermosetting polymer precursor to allow for exhaustion of the gases. The average temperature of the thermosetting polymer precursor during processing can be monitored by a pyrometer.

In an exemplary case, there is little or no absorption of light pulses by a thermosetting polymer precursor film, but there is absorption directly below the thermosetting polymer precursor film. This may be accomplished by placing an optical filter in the path of light pulses to remove portions of the spectrum that would be absorbed by the thermosetting polymer precursor film. If the substrate below the thermosetting polymer precursor film is not absorptive of the light pulses, then an absorber (i.e., light-absorbing layer) may be placed there. When this happens, the curing of the thermosetting polymer precursor film progresses from the bottom of the thermosetting polymer precursor film up to the top surface. This is quite unusual when curing a thin film. Typically, the film is maintained at a constant temperature to crosslink it. As the thermosetting polymer precursor film crosslinks, volatiles are slowly released and diffuse to the boundary(s) of the film. One of the limiting factors of the prior art is that the temperature across the film is uniform, so the curing across the thickness of the thermosetting polymer precursor film is consequently uniform as well. Thus, as the crosslinking progresses, the film itself becomes more of a barrier to the release of the volatiles. This both increases the time to cure the thermosetting polymer precursor film and additionally limits the thickness of the thermosetting polymer precursor film that can be practically manufactured. In contrast, the short light pulses in the present embodiment insure that the temperature at the precursor-absorber interface is higher than any portion of the thermosetting polymer precursor film. Stated another way, the length of each light pulse is shorter than the thermal equilibration time across the thermosetting polymer precursor film. This creates a temperature gradient across the thermosetting polymer precursor film, which means that the crosslinking rate is highest at that interface and decreases as one progresses away from the interface. As the thermosetting polymer precursor film is being cured with subsequent light pulses, the crosslinking progresses from the precursor-absorber interface towards the top of the precursor film.

A big advantage of the inventive method is that the volatile gas that is generated from the crosslinking reaction can easily escape to the top surface as that portion of the thermosetting polymer precursor film has not yet been cured to form a barrier to the volatile gas. In one sense, the curing method of the present invention is similar to how one would prefer a wound to cure: from the bottom up. This process can be called “zipper curing” because it is directional. Just like a wound, as the thickness of the thermosetting polymer precursor film becomes very thin (a few microns), the direction of the curing becomes less critical and consequently, the site of absorption, whether above, below or directly by the precursor of the beam, becomes less critical as well.

After the thermosetting polymer precursor has been cured to form a thermosetting polymer (thermoset) using the above-mentioned method, structures, such as electronic components, conducting traces, additional thermosetting layers, as well as soldering and encapsulation can be formed directly onto the thermoset thin film to form a flexible, thin film circuit board. The curing as described above can be performed on a glass carrier plate which is coated with a light-absorbing layer (LAL) prior to deposition. This dark, thin coating on the glass increases the absorption of the beam and per the method above which enables the “zipper curing” effect. One of the benefits of the class carrier is that it is mechanically stable and very flat. This enables precise placement of components and structures on the thermoset. However, after the circuit board is completed, the carrier plate becomes parasitic mass, and it is desirable to separate it from the thermoset and be reused. The separation of the thermoset from the carrier plate is non-trivial as the thermoset is very thin, is chemically adhered to the carrier plate, and the electronic structures on top are fragile. However, the release of the thermoset from the carrier can be accomplished with the same flashlamp that was used to cure the thermoset by flipping the carrier plate/thermoset stack over and exposing the backside to a short, very intense pulse of light from the flashlamp. The radiant power of this pulse of light is typically greater than 10 times that of the curing settings, and more preferably at least 20 times greater in radiant power. Instead of dozens or even hundreds of small pulses delivered over many seconds for the curing, a single, intense, and very short pulse of light is used to release the thermoset from the carrier. The radiant exposure of the pulse is low: Only a few J/cm² versus about 100 J/cm² for the curing pulse sequence. The LAL absorbs the light from the flashlamp which heats it to the point that the thermoset thermally breaks down at the thermoset-LAL interface. This causes the thermoset to lose adhesion to the LAL and release the thermoset.

Additionally, the pulse of light from the flashlamp is so short that there is not adequate time for heat from the LAL to diffuse through the entire thermoset film to the same high temperature. Thus, the electronic structures on top of the thermoset are not heated significantly. Consequently, the release of the thermoset from the carrier plate results in a circuit board that is undamaged from the release process. An optical filter is not necessary with this process since thickness of the LAL is such that no light passes through it. Thus, the thermoset and electronic structures are not exposed directly to the beam which would otherwise damage them. Rather, the light shines through the glass plate and it absorbed by the LAL. Typically, the LAL is at least 50% absorptive of the flashlamp emission and has a coefficient of thermal expansion (CTE) that is within 50% of the glass substrate. This insures that when the LAL is heated, it does not delaminate from the glass substrate. This enables the reuse of the carrier plate. Additionally, the LAL is as thin as possible while remaining opaque to the flashlamp emission. The reason the LAL is as thin as possible is that the LAL is usually about 100 times more thermally conductive than either the glass substrate or the thermoset. Thus, during the pulse, which is typically 50-400 microseconds, the LAL is thermally equilibrated and is approximately heated to a temperature related to the ratio of the radiant exposure from the flashlamp divided by its areal mass. On these timescales, very little heat is transferred to the glass carrier and the thermoset. So, a thinner LAL requires less power from the flashlamp (which stresses it less) and less heat is deposited into the stack. The LAL is typically composed of metal and a preferred composition is an alloy of 90% tungsten/10% titanium sputtered at 200 nm thick. This film absorbs about 55% of the flashlamp emission and is robust enough that the carrier plate can be reused at least 15 times without degradation. The LAL may be composed of materials other than metals, or alloys including carbon, ceramics, semiconductors, etc. provided they are at least 50% absorptive of the flashlamp beam, have a short extinction coefficient (which means they can be deposited in a thin layer, e.g., less than 300 nm and still be absorptive), and have a CTE that is within 50% of the glass carrier. An exemplary glass carrier material is Eagle XG (Corning, Inc). It has a CTE of ˜3×10⁶/° C. Pure tungsten, of which is 90% of the LAL alloy composition has a CTE of ˜4×10⁶/° C., so the preferred alloy composition is closely matched to the glass substrate.

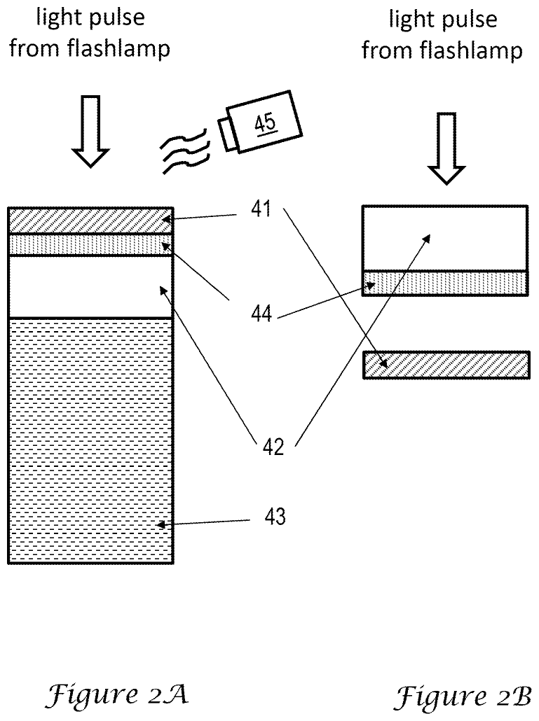

### Example 1: Curing of PI on Light-Absorbing Layer Glass with Subsequent Release from Glass Carrier [FIGS. 2A-2B]

A PI precursor (PI-2525 polyamic acid manufactured by HD Microsystems) was deposited on a 6″ diameter, 0.7 mm thick, Eagle XG glass wafer 42 (manufactured by Corning, Inc.) using the spin coating process. Prior to PI precursor deposition, wafer 42 was coated with a uniform 200 nm thick LAL 44 comprised of 90% tungsten and 10% titanium. Wafer 42 was spun at a rate of 1,000 rpm for 40 seconds during deposition. Carrier solvent in the polyamic acid formulation was removed by placing wafer 42 on a graphite chuck 43 that was maintained at 120° C. and exposed to light from a PulseForge tool model #IX4-52-30 (PulseForge, Inc.) through a 425 nm long pass optical filter to reduce absorption into the polyamic acid layer during the drying process. Wafer 42 was larger than the emission size of the flashlamp, so it was conveyed past the flashlamp while it was pulsing. The pulse rate was synchronized to the conveyance rate to achieve a uniform radiant exposure over the entire wafer 42. Exposure conditions were: 300 V, 3 ms pulse lengths, with an overlap factor of 100 at a stage conveyance rate of 2 feet per minute. Each pulse deposited a radiant exposure of 1 J/cm² for a total exposure of 100 J/cm² for each pass. An air knife 45 was also used during processing to remove gaseous byproducts from the drying and provide cooling to the film to supplement the cooling from chuck 43. The drying step was repeated three times to completely remove all volatile solvents and resulted in a dried 20 μm thick PI precursor (polyamic acid) film 21. After drying, the settings on the flashlamp were changed, the optical filter was removed, and PI precursor film 21 was cured with a more intense, but similar pulse profile. The settings on the flashlamp tool were: 450 V, 1 ms, and OLF=200, stage conveyance rate=0.5 feet per minute in a full spectrum exposure. Air knife 45 was also used during processing to remove gaseous byproducts from the imidization and provide cooling to PI precursor film 41 to supplement the cooling from chuck 43. Each light pulse deposited a radiant exposure of 1.14 J/cm², so the total radiant exposure was 227 J/cm². Imidization of the product was observed through near elimination of FTIR peak between 1,840 and 1,770 cm-1 wave numbers, corresponding to a near elimination of most C═O variants in the coating.

After imidization, PI precursor film 41 was removed from wafer 42 using photonic liftoff, as shown in FIG. 2B. To do this, wafer 42 was removed from chuck 43, flipped over, and exposed to a subsequent series of pulses from a PulseForge model #IX2-95-10 with the following conditions: 850 V, 270 μs, overlap factor=1.3 and stage conveyance rate=5 feet per minute. Each pulse of light deposited a radiant exposure of 5.17 J/cm². The cured PI film was then observed to have zero adhesion to the LAL coated glass wafer.

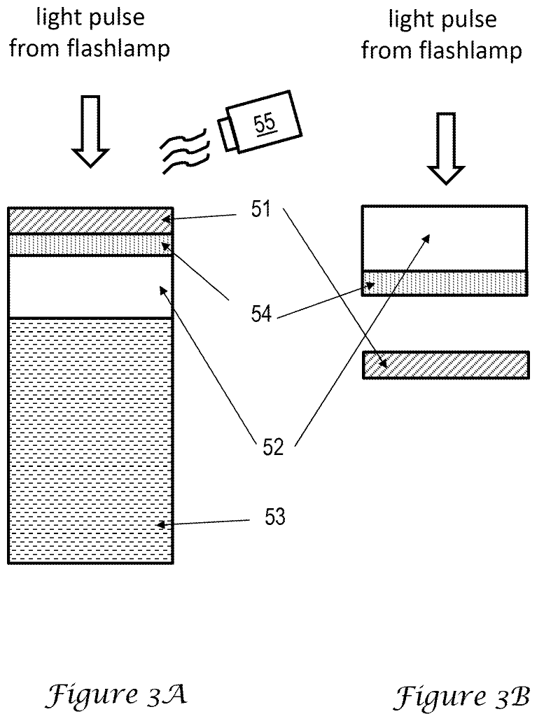

### Example 2: Curing of Epoxy on Light-Absorbing Layer Glass with Subsequent Release from Glass Carrier [FIGS. 3A-3B]

A two-part epoxy (Clear Coat, System Three Resins, Inc. Auburn, WA) which has a working time of approximately 60 minutes and fully cures in 24 hours at room temperature was deposited onto a piece of 0.7 mm thick Eagle XG glass wafer (Corning, Inc.) using a spin coating process to deposit a layer of approximately 20 micron thick. The glass wafer was coated with a uniform 200 nm thick LAL comprised of 90% tungsten and 10% titanium prior to epoxy deposition. The coated wafer was then placed on a graphite chuck that was maintained at 80° C. and exposed to light pulses emitted from a PulseForge tool model #IX4-52-30 (PulseForge, Inc.). Exposure conditions were 480 V, 800 microseconds at 50 Hz for 6 seconds. The radiant exposure of each pulse was 0.83 J/cm² for a total radiant exposure of approximately 250 J/cm². The epoxy was partially cured and turned yellow in the beam due to excessive uv exposure, especially at the top surface. This was not unexpected as UV can often damage epoxies. Next, an identical sample was exposed to the same conditions but with a 425 nm UV cut filter. The total radiant exposure was approximately 220 J/cm². The removal of the UV resulted in a lower radiant exposure of each pulse: 73 J/cm²; however, the epoxy from this condition was completely cured, remained clear, and was free from bubbles. This confirmed that this curing process was not a UV curing process. Alternatively, the full spectrum, e.g., unfiltered, light pulses may be shown from the bottom of the glass to be absorbed by the light-absorbing layer. Since no light can pass through the light-absorbing layer, the epoxy is not exposed to UV. However, in order to do this, the glass wafer cannot be on top of a graphite chuck to cool the glass as the graphite would block the light from the flashlamp. In this case, the glass wafer may be placed on a chuck made from glass, quartz, sapphire, etc., i.e., materials that are transparent to the flashlamp light pulses. The transparent chuck may have temperature-controlled water, which is also transparent to the light pulses, running through it to maintain the glass wafer temperature, and therefore the epoxy, at an average temperature that is at or below the maximum working temperature of the epoxy. An air knife may also be directed on top of the epoxy film while it is being exposed to the flashlamp to provide additional cooling on the film.

After curing, the epoxy film 51 was removed from wafer 52 using photonic liftoff, as shown in FIG. 5B. To do this, wafer 52 was removed from chuck 53, flipped over, and exposed to a subsequent series of pulses from a PulseForge model #IX2-95-10 with the following conditions: 850 V, 270 μs, overlap factor=1.3 and stage conveyance rate=5 feet per minute. Each pulse of light deposited a radiant exposure of 5.17 J/cm². The cured epoxy film was then observed to have zero adhesion to the light-absorbing layer coated glass wafer.

Light-absorbing material absorber layer 54 absorbs some of the light pulses that passes through (i.e., that which is not absorbed by) epoxy film 51. Absorber layer 54 is heated, and transfers its heat to epoxy film 51 via conduction. Effectively, this increases the efficiency of the conversion of the optical energy of the light pulses to heat, which are used to process epoxy film 51. When an optical filter is placed in the light pulse to remove much of the flashlamp emission below 500 nm, LAL 54 below PI precursor film 41 is directly heated, and the majority of the heating of epoxy film 51 is due to thermal conduction from LAL 54. This is advantageous when curing and particularly advantageous when drying epoxy film 51, since the heating is from the surface of absorber layer 54. This directional heating allows for gaseous or volatile products to be exhausted from the top surface of epoxy film 51 as it is processed. In effect, epoxy layer 51 is directionally dried and cured emanating from LAL 54 side to the free surface. This, along with the temperature cycling of epoxy film 51, enables rapid drying and curing of the PI film without damaging it. After epoxy film 51 is dried and cured, the same thin absorber layer 54 is used to aid in removal, or liftoff, of the cured PI from wafer 52. For this step, wafer 52 is flipped over and a flashlamp is shown through glass wafer 52 at very high intensity to LAL 54 to decompose epoxy film 51 at the absorber-PI interface. This allows for subsequent removal of epoxy film 51 with little or no adhesion to wafer 52. In a real-world scenario, electronics or other devices would be formed on the PI after imidization but prior to liftoff. A useful artifact of this process is that any electronics or devices that have been formed on top of epoxy film 51 are never exposed to the beam of light during the liftoff stage because LAL 54 blocks its transmission. Additionally, because the process is so brief, any electronics or structures that are formed on top of epoxy film 51 experience very little temperature increase from the liftoff process. One advantage of the process is that the same piece of hardware can be used to both cure the thermoset and release it from the carrier plate.

As has been described, the present invention provides a method for curing and releasing thermosetting polymers on a coated glass substrate. Examples include polyimide and epoxy, but the method applies to thermosetting polymers in general including acrylics, polyesters, silicones, polyurethanes, phenolics, melamines, benzoxazines, bismaleimides, cyanate esters, thiolytes, vinyl esters, etc.

While the invention has been particularly shown and described with reference to a preferred embodiment, it will be understood by those skilled in the art that various changes in form and detail may be made therein without departing from the spirit and scope of the invention.

What is claimed is:

1. A method for curing thermosetting polymers on a glass substrate, said method comprising:
depositing a light-absorbing layer on a glass substrate;
depositing a thermosetting polymer precursor on said light-absorbing layer in liquid form;
preheating said thermosetting polymer precursor;
exposing said thermosetting polymer precursor to a light pulse from a flashlamp while simultaneously cooling said thermosetting polymer precursor in order to maintain an average temperature of said thermosetting polymer precursor at below its maximum working temperature;
allowing any gaseous by-products to dissipate from said thermosetting polymer precursor after said exposing step; and
repeating said exposing and allowing steps until a thermosetting polymer thin film is formed.

2. The method of claim 2, wherein said method further includes removing fluid from said thermosetting polymer precursor.

3. The method of claim 2, wherein said removing is performed by an oven.

4. The method of claim 2, wherein said removing is performed by a flashlamp.

5. The method of claim 1, wherein said method further includes filtering light pulses from said flashlamp to remove bands light that are absorbed by said thermosetting polymer precursor.

6. The method of claim 1, wherein said thermosetting polymer precursor is polyamic acid.

7. The method of claim 1, wherein said thermosetting polymer precursor is epoxy.

8. The method of claim 1, wherein said cooling is performed by a temperature-controlled heat sink.

9. The method of claim 1, wherein said cooling is performed by an air knife.

10. The method of claim 1, wherein said method further includes
flipping over said glass substrate; and
exposing said glass substrate to another series of light pulses from said flashlamp in order to release said thermosetting polymer film from said light-absorbing layer.

11. The method of claim 1, wherein said light-absorbing layer is a metal.

12. The method of claim 1, wherein said light-absorbing layer is a ceramic.

13. The method of claim 1, wherein said light-absorbing layer is a semiconductor.

14. The method of claim 1, wherein said light-absorbing layer is carbon.

15. The method of claim 1, wherein said light-absorbing layer is less than 300 nm thick.

16. The method of claim 1, wherein a coefficient of thermal expansion of said light-absorbing layer is withing 50% of a coefficient of thermal expansion of said glass substrate.
